(19) United States
(12) Patent Application Publication
(10) Pub. No.: US 2024/0247166 A1
(43) Pub. Date: Jul. 25, 2024

(54) COATING COMPOSITIONS AND ARTICLES COATED THEREWITH

(71) Applicant: PPG Industries Ohio, Inc., Cleveland, OH (US)

(72) Inventors: Rachelle Marie Arnold, Milford, OH (US); Edward Robert Dean, Cincinnati, OH (US); Michael List, Milford, OH (US); Steven Dean Schatz, Milford, OH (US); Krista Rose Smith, Mason, OH (US)

(73) Assignee: PPG Industries Ohio, Inc., Cleveland, OH (US)

(21) Appl. No.: 18/562,457

(22) PCT Filed: May 20, 2022
(86) PCT No.: PCT/US2022/072457

§ 371 Date: Nov. 20, 2023

Related U.S. Application Data
(60) Provisional application No. 63/191,794, filed on May 21, 2021.

(51) Int. Cl. C09D 133/08; B05D 7/16; C08F 220/18; C09D 5/02; C09D 7/42; C09D 7/63

(52) U.S. Cl. CPC C09D 133/08; B05D 7/16; C08F 220/1804; C09D 5/024; C09D 7/42; C09D 7/63; B05D 2202/25

(57) ABSTRACT

An over varnish coating composition that is substantially free of polytetrafluoroethylene comprising a film forming resin, a crosslinking material and a lubricant is described herein. The film-forming resin, such as an acrylic or polyester resin, may have a Tg of 35° C. to 105° C. The over varnish composition may be suitable for coating a package, such as a metal can.

### FIELD

This disclosure relates to over varnish coating compositions useful for coating a variety of substrates, including packaging articles such as food and/or beverage cans.

### BACKGROUND

A wide variety of coatings have been used to coat the surfaces of packaging articles (e.g., food and beverage cans). For example, metal cans are sometimes coated using “coil coating” or “sheet coating” operations, i.e., a planar coil or sheet of a suitable substrate (e.g., steel or aluminum metal) is coated with a suitable composition and hardened (e.g., cured). The coated substrate is then formed into a can end or body. Alternatively, coating compositions may be applied (e.g., by spraying, dipping, rolling, etc.) to the formed article and then cured.

Packaging coatings may be capable of high-speed application to the substrate and provide the necessary properties when hardened to perform in this demanding end use. For example, an external coating for a packaging article should provide for lubricity and abrasion resistance, have excellent adhesion to the substrate, durability, and resist degradation over long periods of time, even when exposed to harsh environments.

In the manufacture of a two-piece metal can for containing beverages and the like, the can body is formed and, before it is filled and the top put in place, the can is decorated, such as by first placing a base coat on the can and printing a label on the can, and then placing an over varnish layer on the can. Exterior protective can coatings, e.g. the over varnish, usually include a lubricant (e.g., a wax), which facilitates manufacture and transport of fabricated metal articles (e.g., food or beverage cans, food or beverage can ends, metal closures for food containers, etc.) by imparting lubricity and/or abrasion resistance to sheets of coated metal substrate. However, these lubricants typically include polytetrafluoroethylene (PTFE) wax and there is a desire by some to reduce or eliminate perfluorooctanoic acid (PFOA) commonly used to formulate PTFE based waxes in coating compositions.

Accordingly, there is a need for improved lubricant systems for use in coatings, such as, for example, in packaging coatings.

### SUMMARY

The present disclosure is directed to an over varnish coating composition comprising a film-forming resin, a crosslinking material, and a lubricant, wherein the over varnish coating composition is substantially free of polytetrafluoroethylene.

The present disclosure is directed to a food and/or beverage packaging coated on at least a portion of an external surface thereof with an over varnish derived from a coating composition comprising a film-forming resin, a crosslinking material, and a lubricant, wherein the coating composition is substantially free of polytetrafluoroethylene.

The present disclosure is directed to a beverage can coated on at least a portion of an external surface thereof with an over varnish derived from a coating composition comprising a film-forming resin, a crosslinking material, and a lubricant, wherein the coating composition is substantially free of polytetrafluoroethylene.

The present disclosure is directed to a beverage can coated on at least a portion of an external surface thereof with a coating comprising an undercoat layer, an ink layer, and an over varnish derived from a coating composition comprising a film-forming resin, a crosslinking material, and a lubricant, wherein the over varnish is substantially free of polytetrafluoroethylene.

The present disclosure is directed to a method of coating a beverage can, the method comprising coating at least a portion of an external surface of the beverage can with an over varnish coating composition comprising a film-forming resin, a crosslinking material, and a lubricant, wherein the coating composition is substantially free of polytetrafluoroethylene.

### DETAILED DESCRIPTION

There is provided an over varnish composition comprising a film-forming resin, a crosslinking material, and a lubricant, wherein the over varnish coating composition is substantially free of polytetrafluoroethylene.

There is also provided a food and/or beverage packaging coated on at least an external portion thereof with an over varnish layer, the over varnish layer being derived from an over varnish composition, the over varnish composition comprising a film-forming resin, a crosslinking material, and a lubricant, wherein the over varnish coating composition is substantially free of polytetrafluoroethylene.

As used herein, an “over varnish layer” means a cured coating layer that is substantially clear, such that the substrate (e.g. aluminum) and/or underlying coating layers (e.g. printed label) are visible therethrough. The over varnish layer may provide a gloss or a matte layer on a substrate. An “over varnish composition”, as used herein, refers to a coating composition that can be used to provide an over varnish layer.

As used herein, “substantially clear” means that an over varnish layer or an over varnish composition comprises less than 5 wt % pigment, such as less than 3 wt %, such as less than 1 wt %, or even less than 0.5 wt % pigment based on the total solid weight of the over varnish layer or over varnish composition. “Pigment” includes any additives that imparts color (rather than texture, such as a matte or satin texture) to the coating layer.

As used herein, “the over varnish layer being derived from an over varnish composition” means that the over varnish composition is applied to a substrate and cured, so as to provide an over varnish layer on the substrate.

The food and/or beverage packaging may be coated on at least a portion of an external surface thereof with the over varnish layer. The food and/or beverage packaging may be coated with coating layers other than the over varnish layer. The over varnish layer may be coated on top of a primer or a basecoat and/or an ink layer. The over varnish layer may form a top coat layer, such as over an ink layer.

The over varnish layer may be derived from any over varnish composition as described herein. Thus, features of the over varnish layer as disclosed herein apply equally to the over varnish composition and vice versa.

The over varnish composition comprises a film-forming resin. The over varnish composition may comprise any suitable film-forming resin. The film-forming resin may comprise a functionalized resin such that the resin comprises functional groups operable to react with a crosslinking material so as to allow the resin to crosslink. Suitable such functional groups include epoxy, ester, amide, keto, vinyl, hydroxyl and/or carboxyl groups or any combination thereof. The film-forming resin may comprise a polyester resin, a polyol resin, a polyurethane resin, an epoxy resin, and/or an acrylic resin.

The film-forming resin may comprise an acrylic polymer and/or a polyester polymer. The acrylic polymer may be a polymer derived from one or more acrylic monomers. Furthermore, blends of acrylic polymers may be used. The acrylic polymer may comprise a staged acrylic polymer and/or a polyester grafted acrylic resin.

The film-forming resin may comprise a polyacrylate resin. A polyacrylate (co)polymer may be formed from a C₁ to C₆ alkyl (C₀ to C₁ alk) acrylate monomer unit. The C₁ to C₆ alkyl (C₀ to C₁ alk) acrylate material may comprise (meth)acrylic acid, methyl (meth)acrylate; ethyl (meth)acrylate; propyl (meth)acrylate; butyl (meth)acrylate. The C₁ to C₆ alkyl (C₀ to C₁ alk) acrylate may comprise a functional group, such as an epoxy group, hydroxyl group or alkoxy methyl ether. A C₁ to C₆ alkyl (C₀ to C₁ alk) acrylate may comprise glycidyl methacrylate, hydroxy ethyl acrylate, hydroxyethyl methacrylate or n-butoxymethylacrylamide. The reaction mixture may further comprise an ethylenically unsaturated monomer. The reaction mixture may comprise an aryl substituted ethylenically unsaturated monomer, such as styrene, for example.

Suitable polyacrylate (co)polymers may comprise a hydroxyl or acid functional solution acrylic resin such as Paraloid AT-746, Paraloid AT-63 Paraloid AT-81, Paraloid AT-147 Paraloid AT-85 or Paraloid AT-9L0 from Dow Chemical and/or a polymer such as Synocryl 7013 SD50 from Arkema. Polyacrylate materials suitable for this disclosure may also include polymers as described in U.S. Pat. No. 7,858,162, of which the portions describing such polyacrylate materials are incorporated herein, such as an acrylic homopolymer or copolymer. Various acrylic monomers can be combined to prepare the acrylic (co)polymer used in the present disclosure. Examples include methyl(meth)acrylate, ethyl(meth)acrylate, butyl(meth)acrylate, hydroxy alkyl(meth)acrylate, 2-ethylhexyl(meth)acrylate, behenyl(meth)acrylate, lauryl(meth)acrylate, allyl(meth)acrylate isobornyl(meth)acrylate, ethylene glycol di(meth)acrylate, (meth)acrylic acid, vinyl aromatic compounds such as styrene and vinyl toluene, nitrites such as (meth)acrylonitrile, and vinyl ester such as vinyl acetate. Any other acrylic monomers known to those skilled in the art could also be used.

The terms “acrylic” and “acrylate” may be used interchangeably (unless to do so would alter the intended meaning) and include acrylic acids, anhydrides, and derivatives thereof, such as their C1-C5 alkyl esters, lower alkyl-substituted acrylic acids, e.g., C1-C2 substituted acrylic acids, such as methacrylic acid, ethacrylic acid, etc., and their C1-C5 alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer. The term “acrylic polymer” refers to polymers prepared from one or more acrylic monomers.

Suitable film-forming resins may include copolymers of polyacrylates with polyester materials. For example, the polyester and acrylate copolymer can be in the form of a graft copolymer. A graft copolymer can be formed using techniques standard in the art. In one method, the polyester is prepared according to conventional methods using the materials described above. The acrylic monomers are then added to the polyester. The acrylic can then be polymerized using a standard free radical initiator. In this manner, the acrylate copolymer is grafted to the already-made polyester. Alternatively, the polyester can be grafted to an already-made acrylic copolymer, for example a maleic anhydride group may be polymerized in the acrylic copolymer and, subsequently, hydroxyl groups from the polyester can be allowed to react with the acrylic to create a graft copolymer; the result will be an acrylic copolymer having polyester moieties grafted thereto. In the methods for grafting, one selects a moiety to be incorporated into the polyester and a monomer to be included with the acrylate monomers that will react with each other. Maleic anhydride may be used in the formation of a polyester and styrene as one of the acrylic monomers. The styrene will react with the maleic anhydride; the acrylic copolymer will grow off of the styrene through the formation of free radicals. The result will be a polyester having acrylic copolymers grafted thereto. It will be appreciated that not all of the acrylic and polyester will graft; thus, there will be some “neat” polyester and some “neat” acrylate copolymer in the solution. Enough of the acrylate copolymer and polyester will graft, however, to compatibilize the two normally incompatible polymers. It will be appreciated that maleic anhydride and styrene are offered as examples of two components that will promote grafting between the normally incompatible polymers, but that the copolymers are not so limited. Other compounds such as fumaric acid/anhydride or itaconic acid/anhydride may be incorporated into a polyester for grafting with a styrene containing acrylic. Other moieties that will promote grafting between the polyester and acrylic can also be used. Any group of compounds can be used for this purpose. All of these compounds are referred to herein as “graft promoting components”. The amount of graft promoting component used in each of the polyester and/or acrylate portions can affect the final product. If too much of these components are used, the product can gel or be otherwise unusable. The graft-promoting components should therefore be used in an amount effective to promote grafting but not to cause gelling. Enough grafting should be effected to allow the polyester and acrylate polymers to be compatible. In the maleic anhydride/styrene example, usually 2 to 6 weight percent maleic with 8 to 30 weight percent styrene can be used, with weight percent being based on the weight of the polyester and the weight of the acrylic, respectively.

The acrylic resin may have any suitable number-average molecular weight (Mn). The acrylic resin may have an Mn of at least 500 Daltons (Da=g/mole). The acrylic resin may have an Mn up to 250,000 Da, such as up to 200,000 Da, such as up to 150,000 Da, or even up to 100,000 Da, or even up to 50,000 Da, or even up to 10,000 Da. The acrylic resin may have an Mn from 500 Daltons (Da=g/mole) to 250,000 Da, such as from 500 Da to 200,000 Da, such as from 500 Da to 150,000 Da, or even from 500 to 100,000 Da, or even from 500 to 50,000 Da, or even from 500 to 10,000 Da.

The number-average molecular weight may be measured by any suitable method. Techniques to measure the number-average molecular weight will be well known to a person skilled in the art. The Mn values as reported herein were determined by gel permeation chromatography using a polystyrene standard according to ASTM D6579-11 (′Standard Practice for Molecular Weight Averages and Molecular Weight Distribution of Hydrocarbon, Rosin and Terpene Resins by Size Exclusion Chromatography′. UV detector: 254 nm, solvent: unstabilized THF, retention time marker: toluene, sample concentration: 2 mg/ml).

The acrylic resin may have any suitable weight-average molecular weight (Mw). The acrylic resin may have an Mw of at least 500 Daltons (Da=g/mole). The acrylic resin may have an Mw up to 250,000 Da, such as up to 200,000 Da, such as up to 150,000 Da, or even up to 100,000 Da, or even up to 50,000 Da, or even up to 10,000 Da. The acrylic resin may have an Mw from 500 Daltons (Da=g/mole) to 250,000 Da, such as from 500 Da to 200,000 Da, such as from 500 Da to 150,000 Da, or even from 500 to 100,000 Da, or even from 500 to 50,000 Da, or even from 500 to 10,000 Da. The weight average molecular weight (Mw) of the acrylic polymer component may be at least 5,000 g/mole, or from 15,000 to 100,000 Daltons. The acrylic polymer may have an acid value of 30 to 70, such as 40 to 60 mg KOH/g; a hydroxyl value of 0 to 100, such as 0 to 70 mg of KOH/g. A person skilled in the art will appreciate that techniques to measure the number-average molecular weight may also be applied to measure the weight-average molecular weight.

The acrylic resin may have any suitable glass transition temperature (Tg). The acrylic resin may have a Tg from −20° C., such as from 0° C., such as from 35° C., such as from 45° C. The acrylic resin may have a Tg up to 120° C., such as up to 105° C., such as up to 100° C., such as up to 85° C., or even up to 75° C. The acrylic resin may have a Tg from 4° C. to 105° C., such as from 4° C. to 100° C., such as from 4° C. to 85° C., or even from 35 to 105° C., or 45 to 105° C., or 50 to 85° C., or even 65 to 85° C.

The glass transition temperature of the polyester resin may be measured by any suitable method. Methods to measure Tg will be well known to a person skilled in the art. The values reported herein were measured according to ASTM D6604-00(2013) (“Standard Practice for Glass Transition Temperatures of Hydrocarbon Resins by Differential Scanning calorimetry”. Heat-flux differential scanning calorimetry (DSC), sample pans: aluminum, reference: blank, calibration: indium and mercury, sample weight: 10 mg, heating rate: 20° C./min).

The acrylic resin may have any suitable gross hydroxyl value (OHV). The acrylic resin may have a gross OHV from 0 to 220 mg KOH/g. The acrylic resin may have a gross OHV from 20 mg KOH/g, such as from 50 mg KOH/g, such as from 100 mg KOH/g, or even from 110 mg KOH/g. The acrylic resin may have a gross OHV of up to 200 mg KOH/g, such as up to 150 mg KOH/g, such as up to 150 mg KOH/g, or even up to 130 mg KOH/g. The acrylic resin may have a gross OHV from 20 to 200 mg KOH/g, such as from 50 to 150 mg KOH/g, such as from 100 to 150 mg KOH/g, or even from 110 to 130 mg KOH/g. The gross OHV may be expressed on solids.

The gross hydroxyl value (OHV) of the acrylic resin may be measured by any suitable method. Methods to measure OHV will be well known to a person skilled in the art. The hydroxyl values reported herein are the number of mg of KOH equivalent to the hydroxyl groups in 1g of material. In such a method, a sample of solid acrylic resin (typically, 0.1 to 3g) is weighed accurately into a conical flask and is dissolved, using light heating and stirring as appropriate, in 20 ml of tetrahydrofuran. 10 ml of 0.1M 4-(dimethylamino)pyridine in tetrahydrofuran (catalyst solution) and 5 ml of a 9 vol % solution of acetic anhydride in tetrahydrofuran (i.e. 90 ml acetic anhydride in 910 ml tetrahydrofuran; acetylating solution) are then added to the mixture. After 5 minutes, 10 ml of an 80 vol % solution of tetrahydrofuran (i.e. 4 volume parts tetrahydrofuran to 1 part distilled water; hydrolysis solution) is added. After 15 minutes, 10 ml tetrahydrofuran is added and the solution is titrated with 0.5M ethanolic potassium hydroxide (KOH). A blank sample is also run where the sample of solid acrylic resin is omitted. The resulting hydroxyl number is expressed in units of mg KOH/g and is calculated using the following equation:

$$Hydroxyl value = \frac{( {V}_{2} - {V}_{1} ) \times molarity of K O H solution ( M ) \times 56.1}{weight of solid sample ( g )}$$

wherein V₁ is the titre of KOH solution (ml) of the polyester sample and V₂ is the titre of KOH solution (ml) of the blank sample. All values for gross hydroxyl value (OHV) reported herein were measured this way.

The acrylic resin may have any suitable acid value (AV). The acrylic resin may have an AV from 0 to 150 KOH/g. The acrylic may have a gross AV from 2 mg KOH/g, such as from 20 mg KOH/g, or even from 30 mg KOH/g, or even from 45 mg KOH/g. The acrylic may have a gross AV up to 100 mg KOH/g, such as up to 70 mg KOH/g, or even up to 55 mg KOH/g. The acrylic may have a gross AV from 2 to 100 mg KOH/g, such as from 20 to 100 mg KOH/g, or even from 40 to 70 mg KOH/g, or even from 45 to 55 mg KOH/g. The AV may be expressed on solids.

As reported herein, the acid value (AV) expressed on solids was determined by titration with 0.1M methanolic potassium hydroxide (KOH) solution. A sample of solid polymer (0.1 to 3g depending on acid number) was weighed accurately into a conical flask and is dissolved, using light heating and stirring as appropriate, in 25 ml of dimethyl formamide containing phenolphthalein indicator. The solution was then cooled to room temperature and titrated with the 0.1M methanolic potassium hydroxide solution. The resulting acid number is expressed in units of mg KOH/g and is calculated using the following equation:

$$Acid value = \frac{titre of K O H solution ( ml ) \times molarity K O H solution ( M ) \times 56.1}{weight of solid sample ( g )}$$

The film-forming resin may comprise a polyester resin. The polyester resin may comprise the reaction product of a polyacid and a polyol.

“Polyacid” and like terms, as used herein, refers to a compound having two or more carboxylic acid groups, such as two, three or four acid groups, and includes an ester of the polyacid (wherein an acid group is esterified) or an anhydride. The polyacid may be an organic polyacid.

The carboxylic acid groups of the polyacid may be connected by a bridging group selected from: an alkylene group; an alkenylene group; an alkynylene group; or an arylene group.

The polyester resin may be formed from any suitable polyacid, such as maleic acid; fumaric acid; itaconic acid; adipic acid; azelaic acid; succinic acid; sebacic acid; glutaric acid; decanoic diacid; dodecanoic diacid; phthalic acid; phthalic anhydride; isophthalic acid; 5-tert-butylisophthalic acid; tetrachlorophthalic acid; tetrahydrophthalic acid; trimellitic acid; trimellitic anhydride; naphthalene dicarboxylic acid; naphthalene tetracarboxylic acid; terephthalic acid; hexahydrophthalic acid; methylhexahydrophthalic acid; dimethyl terephthalate; cyclohexane dicarboxylic acid; chlorendic anhydride; 1,3-cyclohexane dicarboxylic acid; 1,4-cyclohexane dicarboxylic acid; tricyclodecane polycarboxylic acid; endomethylene tetrahydrophthalic acid; endocthylene hexahydrophthalic acid; cyclohexanetetra carboxylic acid; cyclobutane tetracarboxylic acid; esters and/or anhydrides of all the aforementioned acids and combinations thereof. The polyacid may be selected from phthalic acid, phthalic anhydride and/or adipic acid. The polyacid may be selected from isophthalic acid, terephthalic acid, trimellitic anhydride and/or adipic acid.

“Polyol” and like terms, as used herein, refers to a compound having two or more hydroxyl groups, such as two, three or four hydroxyl groups. The hydroxyl groups of the polyols may be connected by a bridging group selected from: an alkylene group; an alkenylene group; and alkynylene group; or an arylene group. The polyol may be an organic polyol.

The polyester resin may be formed from any suitable polyols, such as alkylene glycols, such as ethylene glycol; propylene glycol; diethylene glycol; dipropylene glycol; tricthylene glycol; tripropylene glycol; hexylene glycol; polyethylene glycol; polypropylene glycol and neopentyl glycol; cyclohexanediol; propanediols including 1,2-propanediol; 1,3-propanediol; butyl ethyl propanediol; 2-methyl-1,3-propanediol; and 2-ethyl-2-butyl-1,3-propanediol; butanediols including 1,4-butanediol; 1,3-butanediol; and 2-ethyl-1,4-butanediol; pentanediols including trimethyl pentanediol and 2-methylpentanediol; cyclohexanedimethanol; hexanediols including 1,6-hexanediol; caprolactonediol (such as the reaction product of epsilon-caprolactone and ethylene glycol); polyether glycols, such as poly(oxytetramethylenc)glycol; trimethylol butane; trimethylol propane; dimethylol cyclohexane; glycerol and the like or combinations thereof.

The polyester resin may be formed from an unsaturated polyol, such as trimethylol propane monoallyl ether; trimethylol ethane monoallyl ether; prop-1-ene-1.3-diol or combinations thereof.

The polyol may be selected from trimethylolpropane and/or neopentyl glycol. The polyol may be neopentyl glycol.

The polyester resin may be formed from adipic acid, phthalic anhydride and/or phthalic acid and trimethylolpropane and/or neopentyl glycol. The polyester resin may be formed from adipic acid, phthalic anhydride and/or phthalic acid and neopentyl glycol.

The polyester resin may comprise polymers or copolymers formed from the reaction of diols and diacids; polyols or polyacid components may optionally be used to produce branched polymers.

The polyacids that can optionally be used to produce branched polymers include, but are not limited to, the following: trimellitic anhydride; trimellitic acid; pyromellitic acid; esters and anhydrides of all the aforementioned acids; and mixtures thereof.

The polyols which can optionally be used to produce branched polymers include, but are not limited to the following: glycerine; trimethylol propane; trimethylol ethane; 1,2,6 hexane triol; pentaerythritol; crythritol; di-trimethylol propane; di-pentaerythritol; N,N,N′,N′ tetra (hydroxyethyl)adipindiamide; N,N,N′N′ tetra (hydroxypropyl)adipindiamide; other, primarily hydroxyl, functional branching monomers; or mixtures thereof.

The polyester resin may be formed from any suitable molar ratio of polyacid:polyol. The molar ratio of polyacid:polyol in the polyester resin may be from 20:1, such as from 10:1, such as from 5:1, or even from 2:1. The molar ratio of polyacid:polyol in the polyester resin may be up to 1:20, such as up to 1:10, such as up to 1:5, or even up to 1:2. The molar ratio of polyacid:polyol in the polyester resin may be from 20:1 to 1:20, such as from 10:1 to 1:10, such as from 5:1 to 1:5, or even from 2:1 to 1:2. The molar ratio of polyacid:polyol in the polyester resin may be 1:1.

The polyester resin may be formed from any suitable molar ratio of diacid:diol. The molar ratio of diacid:diol in the polyester resin may be from 10:1, such as from 5:1, such as from 3:1, or even from 2:1. The molar ratio of diacid:diol in the polyester resin may be up to 1:10, such as up to 1:5, such as up to 1:3, or even from 2:1 to 1:2. The molar ratio of diacid:diol in the polyester resin may be from 10:1 to 1:10, such as from 5:1 to 1:5, such as from 3:1 to 1:3, or even from 2:1 to 1:2.

The molar ratio of diacid:diol in the polyester resin may be from 1.5:1, such as from 1.2:1 or even from 1.1:1. The molar ratio of diacid:diol in the polyester resin may be up to 1:1.5, such as up to 1:1.2 or even up to 1:1.1. The molar ratio of diacid:diol in the polyester resin may be from 1.5:1 to 1:1.5, such as from 1.2:1 to 1:1.2 or even from 1.1:1 to 1:1.1.

The polyester resin may optionally be formed from any suitable molar ratio of diacid+diol to polyacid and/or polyol. The polyester resin may comprise a molar ratio of diacid+diol to polyacid and/or polyol of from 100:1. The polyester resin may comprise a molar ratio of diacid+diol to polyacid and/or polyol of up to 1:1, such as up to 5:1, such as up to 20:1, or even up to 50:1. The polyester resin may comprise a molar ratio of diacid+diol to polyacid and/or polyol of from 100:1 to 1:1, such as from 100:1 to 5:1, such as from 100:1 to 20:1, or even from 100:1 to 50:1.

The polyester resin may optionally be formed from an additional monomer, such as a monoacid or monohydric alcohol or combinations thereof. The optional additional monomer may be organic.

The polyester resin may optionally be formed from an additional monoacid. ‘Monoacid’ and like terms, as used herein, refers to compounds having one carboxylic acid group and includes an ester of the monoacid (where the acid group is esterified) or an anhydride. The monoacid may be an organic monoacid.

The polyester resin may optionally be formed from any suitable additional monoacid, such as benzoic acid; cyclohexane carboxylic acid; tricyclodecane carboxylic acid; camphoric acid; benzoic acid; t-butyl benzoic acid; C1-C18 aliphatic carboxylic acids such as acetic acid; propanoic acid; butanoic acid; hexanoic acid; oleic acid; linoleic acid; undecanoic acid; lauric acid; isononanoic acid; fatty acids; hydrogenated fatty acids of naturally occurring oils; esters and/or anhydrides of any of the aforementioned acids and combinations thereof.

The polyester resin may optionally be formed from an additional monohydric alcohol. ‘Monohydric alcohol’ and like terms as used herein, refers to compounds having one hydroxyl group. The monohydric alcohol may be an organic monohydric alcohol.

The polyester resin may optionally be formed from any suitable additional monohydric alcohol, such as benzyl alcohol; hydroxyethoxybenzene; methanol; ethanol; propanol; butanol; pentanol; hexanol; heptanol; dodecyl alcohol; stearyl alcohol; oleyl alcohol; undecanol; cyclohexanol; phenol; phenyl carbinol; methylphenyl carbinol; cresol; monoethers of glycols; halogen-substituted or other substituted alcohols and combinations thereof.

The polyester resin may optionally be formed from any suitable molar ratio of polyacid+polyols: additional monomer. The polyester resin may comprise a molar ratio of polyacid+polyols: additional monomer of from 100:1. The polyester resin may comprise a molar ratio of polyacid+polyols: additional monomer of up to 1:1, such as up to 5:1, such as up to 20:1, or even up to 50:1. The polyester resin may comprise a molar ratio of polyacid+polyols: additional monomer of from 100:1 to 1:1, such as from 100:1 to 5:1, such as from 100:1 to 20:1, or even from 100:1 to 50:1.

The polyester resin may be formed from commercially available polyester resins, such as those sold under the trade name URADIL, such as URADIL 250, URADIL 255, URADIL 258, URADIL SZ 260 or URADIL SZ 262, URULAC 52260 available from DSM and those sold under the trade name ITALESTER such as Italester H 27, Italester H 28, Italester 217 or Italester 218, available from Galstaff MultiResine; those sold under the trade name IDROBEN, such as IDROBEN 2019, IDROBEN 2026 or IDROBEN 3519, available from Benasedo; or combinations thereof.

The polyester resin may have any suitable number-average molecular weight (Mn). The polyester resin may have an Mn of at least 500 Daltons (Da=g/mole). The polyester resin may have an Mn up to 250,000 Da, such as up to 200,000 Da, such as up to 150,000 Da, or even up to 100,000 Da, or even up to 50,000 Da, or even up to 10,000 Da. The polyester resin may have an Mn from 500 Daltons (Da=g/mole) to 250,000 Da, such as from 500 Da to 200,000 Da, such as from 500 Da to 150,000 Da, or even from 500 to 100,000 Da, or even from 500 to 50,000 Da, or even from 500 to 10,000 Da.

The polyester resin may have any suitable weight-average molecular weight (Mw). The polyester resin may have an Mw of at least 500 Daltons (Da=g/mole). The polyester resin may have an Mw up to 250,000 Da, such as up to 200,000 Da, such as up to 150,000 Da, or even up to 100,000 Da, or even up to 50,000 Da, or even up to 10,000 Da. The polyester resin may have an Mw from 500 Daltons (Da=g/mole) to 250,000 Da, such as from 500 Da to 200,000 Da, such as from 500 Da to 150,000 Da, or even from 500 to 100,000 Da, or even from 500 to 50,000 Da, or even from 500 to 10,000 Da.

The polyester resin may have any suitable glass transition temperature (Tg). The polyester resin may have a Tg from −100° C., such as from −75° C., such as from −50° C. The polyester resin may have a Tg up to 120° C., such as up to 100° C., such as up to 50° C., or even up to 10° C. The polyester resin may have a Tg from −100° C. to 120° C., such as from −75° C. to 100° C., such as from −50° C. to 50° C., or even from −50 to 10° C.

The polyester resin may have any suitable gross hydroxyl value (OHV). The polyester resin may have a gross OHV from 0 to 220 mg KOH/g. The polyester resin may have a gross OHV from 20 mg KOH/g, such as from 50 mg KOH/g, such as from 100 mg KOH/g, or even from 110 mg KOH/g. The polyester resin may have a gross OHV of up to 200 mg KOH/g, such as up to 150 mg KOH/g, such as up to 150 mg KOH/g, or even up to 130 mg KOH/g. The polyester resin may have a gross OHV from 20 to 200 mg KOH/g, such as from 50 to 150 mg KOH/g, such as from 100 to 150 mg KOH/g, or even from 110 to 130 mg KOH/g. The gross OHV may be expressed on solids.

The polyester resin may have any suitable acid value (AV). The polyester resin may have an AV from 0 to 150 KOH/g. The polyester may have a gross AV from 2 mg KOH/g, such as from 20 mg KOH/g, or even from 40 mg KOH/g, or even from 45 mg KOH/g. The polyester may have a gross AV up to 100 mg KOH/g, such as up to 70 mg KOH/g, or even up to 55 mg KOH/g. The polyester may have a gross AV from 2 to 100 mg KOH/g, such as from 20 to 100 mg KOH/g, or even from 40 to 70 mg KOH/g, or even from 45 to 55 mg KOH/g. The AV may be expressed on solids.

The film-forming resin may comprise a polyol resin. As used herein, a polyol means a polymer having a hydroxyl functionality of at least two. The hydroxyl groups may be terminal or found within the polymer chain, or a combination thereof. The polymer backbone may comprise additional functionality, such as a polyether, polyester, polyurethane or any combination thereof. The polymer backbone may be linear or branched. Suitable polyol resins include polyethylene glycol bisphenol-A, commercial resins such as Ingevity Capa 2043, Ingevity Capa 2100, Ingevity Capa 3301, Ingevity Capa 3031 (commercially available from Ingevity), JEFFOL PPG-400, JEFFOL PPG-1000, JEFFOL PPG-2000, JEFFOL PPG-2801, JEFFOL PPG-3703, JEFFOL PPG-3706, JEFFOL PPG-3709, JEFFOL FC31-56, JEFFOL G31-43 (commercially available from Huntsman Corporation), Pluracol 1010, Pluracol 2010, Pluracol 628, Pluracol 1016, Pluracol 1158, Pluracol 2100, Pluracol 380, Pluracol 1168, Pluracol 736 (commercially available from BASF), VORANOL 6150 Polyol, VORANOL 2000LM Polyol, VORANOL 1000LM Polyol, VORANOL 8136 Polyol, VORANOL CP 6055 (commercially available from DOW), Lupraphen 1602/1, Lupraphen 1608/2, Lupraphen 2605/1 (commercially available from BASF), DESMOPHEN 1800, DESMOPHEN 1200, DESMOPHEN 670 BA, DESMOPHEN 2060 BD, DESMOPHEN C 1200 (commercially available from Covestro).

If present, the polyol may be present in an amount of up to 40% by weight %, such as up to 35 wt %, such as up to 33 wt %, based on the total solids of the over varnish composition.

The film-forming resin may comprise a polyurethane resin. As used herein, a polyurethane means a polymer with 2 or more urethane linkages within the backbone. The terminal functionality may include hydroxyl, acid and/or amine functionality. The polyurethane resin may also contain co-functionality within the polymer backbone, such as polyester and/or polyether functionality. Suitable polyurethane resins include DAOTAN TW 642540WA, DAOTAN TW 6450/30WA, DAOTAN VTW 1225/40WA (commercially available from Allnex), BAYBOND PU 330, BAYBOND PU 401A, BAYCUSAN C 1000/1, BAYCUSAN C 1010, BAYHYDROL U 2698, BAYHYDROL U 2750, DESMOCOLL 176, DESMOCOLL 400/1, DESMOLAC 2100 (commercially available from Covestro), NEOREZ U-371, NEOREZ U-397, URAFLEX EU220 M1 (commercially available from DSM).

The film-forming resin may comprise an epoxy resin. As used herein an epoxy resin is a polymer with 2 or more epoxy, oxirane and/or glycidyl ether functional groups. The epoxy functional groups may be terminal or contained within a substructure of the polymer backbone. The epoxy resin may be formed from bisphenol, cycloaliphatic or derivatives thereof. Suitable examples include D.E.R.™ 331. D.E.R.™ 351, D.E.R.™ 354, D.E.R.™ 3572, D.E.R.™ 915, D.E.R.™ 900, D.E.N.™ 425, D.E.N.™ 431 (commercially available from DOW), ARALDITE GY 260, ARALDITE GY 240, ARALDITE PY 306, ARALDITE ECN 1400 (commercially available from Huntsman Corporation), EPI-REZ Resin WD-510, EPI-REZ Resin 7510-W-60, EPON Resin 828, EPON Resin 869 (commercially available from Hexion).

The over varnish composition may comprise from 40 wt %, such as from 45 wt %, such as from 48 wt % of the film-forming resin based on the total solid weight of the over varnish composition. The over varnish composition may comprise up to 80 wt %, such as up to 70 wt %, such as up to 55 wt % of the film-forming resin based on the total solid weight of the over varnish composition. The over varnish composition may comprise from 40 to 80 wt % of the film-forming resin based on the total solid weight of the over varnish composition. The over varnish composition may comprise from 45 to 80 wt %, such as from 55 to 80 wt % of the film-forming resin based on the total solid weight of the over varnish composition.

The over varnish composition may further comprise a crosslinking material.

The crosslinking material may comprise a chemical group suitable for crosslinking the film-forming resin. For example, the crosslinking material may comprise: a phenolic group, a melamine group, a hydroxyl substituted aromatic group; an isocyanate group; an amino group; an amine group; a urea-formaldehyde and/or an alkylated urea with imino functionality. The crosslinking material may comprise an amino group. The crosslinking material may be in the form of a single molecule, a dimer, an oligomer, a (co)polymer or a mixture thereof.

The crosslinking material may comprise a phenol and/or a melamine material.

Suitable isocyanate containing crosslinking material may comprise IPDI (isophorone diisocyanate) like DESMODUR VP-LS 2078/2 or DESMODUR PL 340 (DESMODUR crosslinkers commercially available from Covestro) or VESTANAT B 1370 or VESTANAT B1358A (VESTANAT crosslinkers commercially available from Evonik) or blocked aliphatic polyisocyanate based on HDI like DESMODUR BL3370 or DESMODUR BL 3175 SN (commercially available from Covestro) or DURANATE MF-K60X (commercially available from Asahi KASEI) or TOLONATE D2 (commercially available from Vencorex Chemicals) and/or TRIXENE-BI-7984 or TRIXENE 7981 (commercially available from Lanxess).

Suitable water thinnable isocyanate crosslinking materials may comprise BAYHYDUR BL2781, BAYHYDUR BL5140, BAYHYDUR 2655 (commercially available from Covestro), AQUALINK X, and/or AQUALINK U-HT (commercially available from Aquaspersions).

Suitable amino containing crosslinking material may comprise a Melamine formaldehyde type material of the hexakis(methoxymethyl)melamine (HMMM) type such as KOMELOL 90GE (commercially available from Melamin), MAPRENAL MF900 (commercially available from Prefere Melamines) or RESIMENE 745 or RESIMENE 747 (commercially available from Prefere Melamines) or CYMEL 303 and/or CYMEL MM100 (commercially available from Allnex). Other melamine formaldehyde type material such as butylated methylol melamine type resins such as CYMEL 1156 or CYMEL 1158 (commercially available from Allnex) or mixed ether type methylal melamine resins such as CYMEL 1116, CYMEL 1130, CYMEL 1133 or CYMEL 1168 (commercially available from Allnex) or part methylolated and part methalated melamine type resins such as CYMEL 370, CYMEL 325 or CYMEL 327 (commercially available from Allnex).

Other types of suitable amino containing crosslinking material may comprise a benzoguanamine formaldehyde type material such as CYMEL 1123 (commercially available from Allnex), ITAMIN BG143 (commercially available from Galstaff Multiresine) or MAPRENAL (Uramex) BF891 and/or MAPRENAL BF892 (commercially available from Prefere). Further examples of suitable amino containing crosslinking agents include glycouril based materials such as CYMEL 1170 and CYMEL 1172 (commercially available from Allnex).

Suitable urca-formaldehyde containing crosslinking material may comprise CYMEL U-80 or CYMEL U-60 (commercially available from Allnex), MAPRENAL UF 264 (commercially available from Prefere), ASTRO SET 90 (commercially available from Momentive), CURAZINE 42-316 or CURAZINE 42-338 or CURAZINE 42-360 or CURAZINE 42-365 or CURAZINE 42-367 and/or CURAZINE 42-378 (commercially available from Bitrez).

Suitable amine containing crosslinking material may comprise Triethylenetetramine (commercially available from Dow), ARADUR 115 BD, 125BD, 140BD (commercially available from Huntsman), dicyandiamide (commercially available from AlzChem) and/or CASAMID DMPFF.

The crosslinking material may be used in the over varnish composition in any suitable amount. The crosslinking material may be used in amounts from 10 wt %, such as from 15 wt %, or from 20 wt %, or from 25 wt %, or from 35 wt % based on the total solid weight of the over varnish composition. The crosslinking material, when present, may be used in amounts up to 50 wt %, such as up to 45 wt % based on the total solid weight of the over varnish composition. The crosslinking material, when present, may be used in amounts from 10 to 50 wt %, or from 10 to 30 wt %, such as from 15 to 30 wt % based on the total solid weight of the over varnish composition.

The film-forming resin may be in the over varnish composition in amounts of 40 to 90, preferably 50 to 85 percent by weight, and the crosslinking material is present in amounts of 5 to 50, preferably 15 to 30 percent by weight, the percentages by weight being based on the weight of total resin solids in the coating composition. The resin solids, including the film forming resin and crosslinking material, are present in an amount of 30 to 85 percent by weight of the total solids in the over varnish composition.

The lubricant may include a wax. As used herein, “wax” refers to an organic substance that is solid at ambient conditions and forms a liquid when heated. Examples of suitable waxes include microcrystalline wax, polyethylene wax, carnauba wax, lanolin wax, Fischer-Tropsch wax, paraffin wax, Castor wax, polypropylene wax, and/or amide derivatives of the former. For example, the lubricant may comprise a microcrystalline polyethylene wax.

The lubricant may be used in the over varnish composition in any suitable amount. The lubricant may be used in amounts from 0.01 wt %, such as from 0.1 wt %, such as from 0.5 wt %, or from 1 wt %, or from 1.5 wt %, based on the total solid weight of the over varnish composition. The lubricant, when present, may be used in amounts up to 20 wt %, such as up to 15 wt %, up to 10%, or up to 5 wt %, based on the total solid weight of the over varnish composition. The lubricant, when present, may be used in amounts from 0.1 to 5 wt %, or from 1 to 5 wt %, such as from 1 to 4 wt % based on the total solid weight of the over varnish composition.

The over varnish compositions described herein may be prepared according to methods well known in the art. For example, using an acid functional acrylic polymer as the resinous vehicle, the polymer is neutralized with an amine to between 20-110 percent of the total theoretical neutralization. The neutralized acrylic polymer is then dispersed in water to achieve a manageable viscosity. Crosslinking materials and additives are then added followed by thinning with additional water to achieve the desired solids and viscosity.

The over varnish composition may comprise a solvent, and may be a water-borne or a solvent-borne composition.

When the over varnish composition is a water-borne composition, the composition may comprise water as a solvent, such that the majority of the solvent in the over varnish composition is water, i.e. such that the over varnish composition comprises less than 20 wt %, such as less than 15 wt %, such as less than 12 wt %, of an organic (i.e. non-aqueous) solvent based on the total weight of the over varnish composition.

When the over varnish composition is a water-borne composition, the composition may comprise a solvent, wherein the majority of the solvent is water, i.e. such that the solvent comprises less than 35 wt %, such as less than 30 wt %, such as less than 27 wt %, of an organic (i.e. non-aqueous) solvent based on the total weight of the solvent in the over varnish composition.

When the over varnish composition is solvent-borne, the composition may comprise an organic (i.e. non-aqueous) solvent, such that the majority of the solvent in the over varnish composition is an organic solvent, i.e. such that the over varnish composition comprises less than 10 wt %, such as less than 5 wt %, such as less than 2 wt %, of water based on the total weight of the over varnish composition.

The over varnish composition may comprise from 20 wt %, such as from 25 wt %, such as from 30 wt %, of solvent (water or organic solvent) based on the total weight of the over varnish composition. The over varnish composition may comprise up to 60 wt %, such as up to 52 wt %, of solvent (water or organic solvent) based on the total weight of the over varnish composition. The over varnish composition may comprise from 20 to 60 wt %, such as 25 to 60 wt %, such as 30 to 52 wt %, of solvent (water or organic solvent) based on the total weight of the over varnish composition.

When the over varnish composition comprises an organic solvent, any suitable organic solvent may be used. A suitable organic solvent may comprise an alcohol, ester, ketone, glycol, glycol ether, glycol ether ester, aromatic hydrocarbon, aliphatic hydrocarbon, and/or a derivative thereof, such as diethylene glycol monobutylether, di(propylene glycol) methyl ether, 2-butoxyethanol, xylene, toluene, aromatic solvent 100, aromatic solvent 150, 2-butoxyethyl acetate, 2-(2-butoxyethoxy)ethyl acetate, ethyl acetate, n-propyl acetate, n-butyl acetate, isobutyl acetate, n-butyl alcohol, isobutyl alcohol, 1-methoxy-2-propyl acetate, n-propyl alcohol, cyclohexanone, cyclopentanone, methyl-isobutyl ketone, and/or 2-butanone.

The over varnish composition may be substantially free, such as essentially free or completely free, of perfluorooctanoic acid (PFOA) and derivatives thereof. As used herein, “substantially free” in relation to perfluorooctanoic acid and derivatives thereof means that the over varnish compositions (and over varnish layers derived therefrom) contain less than 1000 parts per million (ppm) of perfluorooctanoic acid and derivatives thereof. As used herein, “essentially free” means that the over varnish compositions (and over varnish layers derived therefrom) contain less than 100 ppm of perfluorooctanoic acid and derivatives thereof. As used herein, “completely free” means that the over varnish compositions (and over varnish layers derived therefrom) contain less than 20 parts per billion (ppb) of perfluorooctanoic acid and derivatives thereof. Derivatives of perfluorooctanoic acid include polytetrafluoroethylene (PTFE). Accordingly, the over varnish composition may be substantially free, such as essentially free or completely free, of polytetrafluoroethylene. It is desirable to reduce levels of perfluorooctanoic acid, as perfluorooctanoic acid is thought to be carcinogenic and has been linked to cancers and damage to the unborn child, such that its use in coatings is to be prevented and/or reduced.

The compositions may be substantially free, may be essentially free or may be completely free of bisphenol A and derivatives or residues thereof, including bisphenol A (“BPA”) and bisphenol A diglycidyl ether (“BADGE”). Such compositions are sometimes referred to as “BPA non intent” because BPA, including derivatives or residues thereof, are not intentionally added but may be present in trace amounts because of unavoidable contamination from the environment. The compositions may also be substantially free, may be essentially free, or may be completely free of bisphenol F and derivatives or residues thereof, including bisphenol F and bisphenol F diglycidyl ether (“BPFG”). The term “substantially free” as used in this context means the compositions or resulting coating contain less than 1000 parts per million (ppm), “essentially free” means less than 100 ppm and “completely free” means less than 20 parts per billion (ppb) of any of the above-mentioned compounds, derivatives or residues thereof.

The coating compositions may be substantially free, may be essentially free or may be completely free of dialkyltin compounds, including oxides or other derivatives thereof, for example when used in packaging applications. Examples of dialkyltin compounds include, but are not limited to the following: dibutyltindilaurate (DBTDL); dioctyltindilaurate; dimethyltin oxide; diethyltin oxide; dipropyltin oxide; dibutyltin oxide (DBTO); dioctyltinoxide (DOTO) or combinations thereof. The term “substantially free” as used in this context means the compositions or resulting coating contain less than 1000 parts per million (ppm), “essentially free” means less than 100 ppm and “completely free” means less than 20 parts per billion (ppb) of any of the above-mentioned compounds, derivatives or residues thereof.

The over varnish coating compositions may be substantially free of styrene. The coating compositions may be essentially free or may be completely free of styrene. The term “substantially free” as used in this context means the compositions or resulting coating contain less than 1000 parts per million (ppm), “essentially free” means less than 100 ppm and “completely free” means less than 20 parts per billion (ppb) of any of the above-mentioned compounds, derivatives or residues thereof.

The over varnish coating compositions may be substantially phenol free, or essentially phenol free, or completely phenol free. The term “substantially free” as used in this context means the compositions or resulting coating contain less than 1000 parts per million (ppm), “essentially free” means less than 100 ppm and “completely free” means less than 20 parts per billion (ppb) of any of the above-mentioned compounds, derivatives or residues thereof.

The over varnish coating compositions may be substantially formaldehyde free, or essentially formaldehyde free, or completely formaldehyde free. The term “substantially free” as used in this context means the compositions or resulting coating contain less than 1000 parts per million (ppm), “essentially free” means less than 100 ppm and “completely free” means less than 20 parts per billion (ppb) of any of the above-mentioned compounds, derivatives or residues thereof.

The over varnish composition may further comprise one or more additives such as an adhesion promoter, a plasticizer, a surfactant, a flow control agent, a defoamer, a thixotropic agent, a filler, a diluent, an organic solvent, a slip agent, a wetting agent, an optical brightener, a stabilizer, and/or an odor masking agent. The over varnish composition may comprise other optional additives well known in the art of formulating coatings, such as matting agents, levelling agents, plasticizers, abrasion-resistant particles, anti-oxidants, hindered amine light stabilizers, UV light absorbers and stabilizers, surfactants, grind vehicles, and/or other customary auxiliaries. The additive, when present, may be used in the over varnish composition in any suitable amount. For example, the additive may be used in amounts of at least 0.001 wt %, such as 0.01 wt %, such as 0.05 wt %, such as 0.1 wt %, based on the total solid weight of the over varnish composition. The additive, when present, may be used in amounts up to 20 wt %, such as up to 15 wt %, such as up to 10 wt %, such as up to 5 wt %, such as up to 3 wt %, such as up to 2 wt %, based on the total solid weight of the over varnish composition. The additive, when present, may be used in amounts 0.001 to 15 wt %, such as 0.001 to 10 wt %, such as 0.01 to 5 wt %, such as 0.05 to 3 wt %, such as 0.1 to 2 wt %, based on the total solid weight of the over varnish composition.

The over varnish composition may further comprise a catalyst. Any catalyst typically used to catalyze crosslinking reactions between film-forming resins and/or between film-forming resins and crosslinking materials may be used. Suitable catalysts will be well known to the person skilled in the art. The catalyst may be a non-metal or a metal catalyst or a combination thereof. Suitable non-metal catalysts include, but are not limited to the following: phosphoric acid; blocked phosphoric acid; phosphatized resins such as, for example, phosphatized epoxy resins and phosphatized acrylic resins; CYCAT (RTM) XK 406 N (commercially available from Allnex); sulfuric acid; sulfonic acid; CYCAT 600 (commercially available from Allnex); NACURE (RTM) 155 or NACURE 2500(commercially available from King industries); NACURE (RTM) 5076 or NACURE 5925(commercially available from King industries); phenyl acid phosphate catalyst; acid phosphate catalyst such as NACURE XC 235 (commercially available from King Industries); para-toluene sulfonic acid such as NACURE 2547 (commercially available from King Industries); and combinations thereof. Suitable metal catalysts will be well known to the person skilled in the art. Suitable metal catalysts include, but are not limited to the following: tin containing catalysts, such as monobutyl tin tris (2-ethylhexanoate); zirconium containing catalysts, such as KKAT (RTM) 4205 (commercially available from King Industries); titanate based catalysts, such as tetrabutyl titanate TnBT (commercially available from Sigma Aldrich); and combinations thereof.

The catalyst, when present, may be used in the over varnish composition in any suitable amount. The catalyst, when present, may be used in amounts of at least 0.001 wt %, such as at least 0.01 wt %, such as at least 0.05 wt %, such as at least 0.1 wt %, such as at least 0.2 wt % based on the total solid weight of the over varnish composition. The catalyst, when present, may be used in amounts up to 10 wt %, such as up to 5 wt %, such as up to 3 wt %, such as up to 2 wt %, such as up to 1 wt %, based on the total solid weight of the over varnish composition. The catalyst, when present, may be used in amounts 0.001 to 10 wt %, such as 0.01 to 5 wt %, such as 0.1 to 5 wt %, such as 0.1 to 2 wt %, such as 0.2 to 1 wt %, based on the total solid weight of the over varnish composition.

The over varnish composition may be a single component composition (often referred to as a 1K coating composition) or a multiple component composition, such as a two-component coating composition (often referred to as a 2K coating composition). Such terminology is well known in the art. In a multiple component coating composition, the components are provided separately but introduced to each other (by mixing, for example) prior to application. This could be hours before application, for example up to 8 hours before application or up to 4 hours before application. In some instances, the multiple components may be introduced to each other (such as by mixing) during the application process, such as in line mixing, for example. If the over varnish composition is a multiple component composition, such as a 2-component coating composition, the film-forming resin may be provided in a first component, while other materials may be provided in a further component (such as a second component). For example, the crosslinking material may be provided in a further component (such as a second component).

The present disclosure also extends to an article, such as a food and/or beverage packaging, coated on at least a portion thereof with an over varnish layer, the over varnish layer being derived from the over varnish composition disclosed herein.

According to the present disclosure there is provided a substrate, such as a metal can, coated on at least a portion thereof with an over varnish layer, the over varnish layer being derived from the over varnish composition as described herein.

Examples of suitable metal substrates include, but are not limited to, food and/or beverage packaging, components used to fabricate such packaging, and monobloc aerosol cans and/or tubes.

The food and/or beverage packaging may be a can. Examples of cans include, but are not limited to, two-piece cans, three-piece cans and the like. The food and/or beverage packaging may be a two-piece metal can. Suitable examples of monobloc aerosol cans and/or tubes include, but are not limited to, deodorant and hair spray containers. Monobloc aerosol cans and/or tubes may be aluminum monobloc aerosol cans and/or tubes.

The substrate may be a package coated at least in part with any of the coating compositions described above. A “package” is anything used to contain another item, particularly for shipping from a point of manufacture to a consumer, and for subsequent storage by a consumer. A package will be therefore understood as something that is sealed so as to keep its contents free from deterioration until opened by a consumer. The manufacturer will often identify the length of time during which the food or beverage will be free from spoilage, which typically ranges from several months to years. Thus, the present “package” is distinguished from a storage container or bakeware in which a consumer might make and/or store food; such a container would only maintain the freshness or integrity of the food item for a relatively short period. A package can be made of metal or non-metal, for example, plastic or laminate, and be in any form. An example of a suitable package is a laminate tube. Another example of a suitable package is metal can. The term “metal can” includes any type of metal can, container or any type of receptacle or portion thereof that is sealed by the food and/or beverage manufacturer to minimize or eliminate spoilage of the contents until such package is opened by the consumer. One example of a metal can is a food can; the term “beverage can(s)” is used herein to refer to cans, containers or any type of receptacle or portion thereof used to hold any type of food and/or beverage. The term “metal can(s)” specifically includes beverage cans and also specifically includes “can ends” including “E-Z open ends”, which are typically stamped from can end stock and used in conjunction with the packaging of food and beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two piece cans” and “three-piece cans” as well as drawn and ironed one-piece cans; such one piece cans often find application with aerosol products.

The over varnish coating composition may be applied to the food and/or beverage packaging by any means known in the art. Suitable application methods for the over varnish compositions of the present disclosure include, but are not limited to the following: electrocoating such as electrodeposition, spraying, electrostatic spraying, dipping, rolling, brushing, lamination, and the like.

The over varnish composition may be applied to any suitable dry film thickness. The over varnish composition may be applied to a dry film thickness up to 25 microns (μm), such as up to 20 μm, such as up to 15 μm, or even up to 10 μm. The over varnish composition may be applied to a dry film thickness of at least 0.5 μm, at least 1 μm, at least 2 μm, at least 3 μm, at least 4 μm, at least 5 μm, or even at least 10 μm. The over varnish composition may be applied to a dry film thickness of at least 2 μm. The over varnish composition may be applied to a dry film thickness from 2 to 25 microns (μm), such as from 2 to 20 μm, such as from 2 to 15 μm, or even from 2 to 10 μm, or from 2 to 5 μm.

The over varnish composition may be applied to the substrate by rolling. Thus, the over varnish composition may be a roll coated composition. For the avoidance of doubt, by the term ‘roll coated composition’ and like terms as used herein is meant, unless specified otherwise, that the composition is suitable to be applied to a substrate by rolling, i.e. is capable of being roll coated.

The over varnish composition may be applied to the substrate by spraying. Thus, the over varnish composition may be a spray composition. For the avoidance of doubt, by the term ‘spray composition’ and like terms as used herein is meant, unless specified otherwise, that the composition is suitable to be applied to a substrate by spraying, i.e. is sprayable.

The over varnish composition may be applied to a substrate, or a portion thereof, as a single layer or as part of a multi-layer system. The over varnish composition may be applied as a single layer, i.e. to form an over varnish layer. The over varnish composition may be applied to an uncoated substrate. For the avoidance of doubt an uncoated substrate extends to a surface that is cleaned prior to application. The over varnish composition may be applied on top of another paint layer as part of a multi-layer system. For example, the over varnish composition may be applied on top of a primer or an intermediate layer. The over varnish compositions may form a top coat (over varnish) layer.

The over varnish compositions may be applied to a substrate once or multiple times.

The application of various pre-treatments and coatings to substrates such as monobloc aerosol cans is well established. Such treatments and/or coatings, for example, may be used to provide a decorative coating. The over varnish composition may form an over varnish layer over a decorative coating so as to protect the decorative coating from abrasion and/or damage. The over varnish layer may also provide a decorative glossy finish. The over varnish composition may be applied to the exterior of a food and/or beverage can.

After application, the coating is then cured. Curing the coating compositions may form a cured film.

The coating composition may be cured by any suitable method. The coating composition may be cured by heat curing, radiation curing, or by chemical curing, such as by heat curing. The coating composition, when heat cured, may be cured at any suitable temperature. The over varnish composition may be cured thermally, i.e. such as by heating to a temperature up to 250° C., such as up to 220° C., such as up to 180° C., or such as by heating to a temperature from 80 to 250° C., such as from 120 to 220° ° C., such as from 160 to 220° C. The coating composition, when heat cured, may be cured to a peak metal temperature (PMT) of 150° C. to 350° C., such as from 175° C. to 320° C., such as from 190° C. to 300° C., or even from 170° C. to 230° C. The coating composition, when heat cured, may be cured at 210° C. or at 260° C. If a further layer is applied to the substrate after the over varnish layer described herein, then this further layer may comprise a coating composition that may be thermally cured at a temperature of up to 250° C., such as from 80 to 250° C.

For the avoidance of doubt, the term “peak metal temperature”, and like terms as used herein, is meant unless specified otherwise the maximum temperature reached by the metal substrate during exposure to a heat during the heat curing process. In other words, the peak metal temperature (PMT) is the maximum temperature reached by the metal substrate and not the temperature which is applied thereto. It will be appreciated by a person skilled in the art that the temperature reached by the metal substrate may be lower than the temperature which is applied thereto or may be substantially equal to the temperature which is applied thereto. The temperature reached by the metal substrate may be lower that the temperature which is applied thereto.

The thermal curing may be carried out in one or more cycles. For example, the coatings may go through two cure cycles in which the temperature and the duration of cure may be the same or may be different. The thermal curing in each cycle, independently, may be carried out for at least 1 minute, such as from 2 minutes, or from 3 minutes, or even from 4 minutes, or from 5 minutes. The thermal curing may be carried out for up to 10 minutes, such as up to 8 minutes, up to 7 minutes, or up to 5 minutes. The thermal curing may be carried out for from 1 to 10 minutes, such as from 1 to 8 minutes, such as from 3 to 7 minutes, or 1 to 5 minutes.

Also provided herein is a food and/or beverage packaging coated on at least a portion of an external surface thereof with an over varnish derived from a coating composition comprising a film-forming resin, a crosslinking material, and a lubricant, wherein the coating composition is substantially free of polytetrafluoroethylene.

The present disclosure also contemplates a beverage can coated on at least a portion of an external surface thereof with an over varnish derived from a coating composition comprising a film-forming resin, a crosslinking material, and a lubricant, wherein the coating composition is substantially free of polytetrafluoroethylene.

Also disclosed herein is a beverage can coated on at least a portion of an external surface thereof with a coating comprising an undercoat layer, an ink layer, and an over varnish derived from a coating composition comprising a film-forming resin, a crosslinking material, and a lubricant, wherein the over varnish is substantially free of polytetrafluoroethylene.

A method of coating a beverage can is provided wherein the method comprises coating at least a portion of an external surface of the beverage can with an over varnish coating composition comprising a film-forming resin, a crosslinking material, and a lubricant, wherein the coating composition is substantially free of polytetrafluoroethylene.

For purposes of the detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

As used herein, unless indicated otherwise, singular encompasses plural and vice versa. For example, although reference is made herein to “a” crosslinking material, “a” film-forming resin, “a” lubricant, “a” matting agent, and the like, one or more of each of these and any other components can be used.

As used herein, “including.” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

As used herein, the terms “on.” “onto,” “applied on,” “applied onto,” “formed on,” “deposited on,” “deposited onto,” mean formed, overlaid, deposited, or provided on but not necessarily in contact with the surface. For example, a coating composition “deposited onto” a substrate does not preclude the presence of one or more other intervening coating layers of the same or different composition located between the coating composition and the non-porous substrate.

The term “alk” or “alkyl”, as used herein unless otherwise defined, relates to saturated hydrocarbon radicals being straight, branched, cyclic or polycyclic moities or combinations thereof and contain 1 to 20 carbon atoms, such as 1 to 10 carbon atoms, such as 1 to 8 carbon atoms, such as 1 to 6 carbon atoms, or even 1 to 4 carbon atoms. These radicals may be optionally substituted with a chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, aryl or Het, wherein R¹⁹ to R²⁷ each independently represent hydrogen, aryl or alkyl, and/or be interrupted by oxygen or sulphur atoms, or by silano or dialkylsiloxane groups. Examples of such radicals may be independently selected from methyl, ethyl, n-propyl, isopropyl, n-butyl, isobutyl, see-butyl, tert-butyl, 2-methylbutyl, pentyl, iso-amyl, hexyl, cyclohexyl, 3-methylpentyl, octyl and the like. The term “alkylene”, as used herein, relates to a bivalent radical alkyl group as defined above. For example, an alkyl group such as methyl which would be represented as —CH₃, becomes methylene, —CH₂—, when represented as an alkylene. Other alkylene groups should be understood accordingly.

Also, the recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2. 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The terms “comprising”, “comprises” and “comprised of” as used herein are synonymous with “including”, “includes” or “containing”, “contains”, and are inclusive or open-ended and do not exclude additional, non-recited members, elements or method steps. Additionally, although the present disclosure has been described in terms of “comprising”, the coating compositions detailed herein may also be described as “consisting essentially of” or “consisting of”.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

As used herein, the term “polymer” refers broadly to prepolymers, oligomers and both homopolymers and copolymers. It should be noted that the prefix “poly” refers to two or more.

Whereas specific embodiments of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

For a better understanding of the disclosure, and to show how embodiments of the same may be carried into effect, reference will now be made, by way of example, to the following examples.

### Examples

### Preparation of Acrylic Resins

Acrylics having different glass transition temperatures (Tg) as shown in Table 1 were prepared according to the following procedure (amounts given in percent by weight):
1. Charge #1 was added to round bottom reaction flask. Condenser water and nitrogen blanket were turned on. Mixture was heated to 320-325 F, temperature set point at 323° F.
2. Batch temperature 320-325° F., charge #2 and 67.07% charge #3 were added over 180 minutes.
3. Once the feed was complete, rinse charge #4 was added. Batch was held for 15 minutes.
4. Once the hold was complete, 32.93% charge #3 was added over 20 minutes.
5. When charge #3 addition was complete, rinse charge #6 was added. Batch was held 30 minutes.
6. Once the hold was complete, batch set point was reduced to 180 ºF.
7. Once batch temperature was below 240° F., charge #7 was added.
8. When charge #7 was complete, charge #8 was added over 45 minutes.
9. When charge #8 was complete, full cooling was applied. More deionized water was added if necessary to reach desired viscosity.

TABLE 1
Acrylics having different Tgs

| | | | 35° C. Tg | 53° C. Tg | 85° C. Tg | 100° C. Tg |
|---|---|---|---|---|---|---|
| Charge | Material | Function | Example | Example | Example | Example |
| 1 | Butyl Cellosolve | Solvent | 5.08 | 5.08 | 5.08 | 4.06 |
| 2 | Methacrylic Acid | Monomer | 2.90 | 2.90 | 2.90 | 2.32 |
| | Ethyl Methacrylate | Monomer | 0.00 | 0.00 | 6.49 | 4.50 |
| | Methyl | Monomer | 0.00 | 0.00 | 0.00 | 2.73 |
| | Methacrylate | | | | | |
| | Butyl Methacrylate | Monomer | 10.44 | 10.60 | 0.00 | 0.00 |
| | Ethyl Acrylate | Monomer | 5.73 | 0.00 | 0.00 | 0.00 |
| | Methyl Acrylate | Monomer | 0.00 | 3.61 | 2.55 | 0.00 |
| | Styrene | Monomer | 5.10 | 7.07 | 12.24 | 9.79 |
| 3 | T-Butyl | Initiator | 0.83 | 0.83 | 0.83 | 0.66 |
| | Perbenzoate | | | | | |
| | Butyl Cellosolve | Solvent | 1.94 | 1.94 | 1.94 | 1.55 |
| 4 | Butanol | Solvent | 0.44 | 0.44 | 0.44 | 0.35 |
| 5 | Butanol | Solvent | 0.17 | 0.17 | 0.17 | 0.14 |
| 6 | Butanol | Solvent | 0.83 | 0.83 | 0.83 | 0.67 |
| 7 | DMEA | Neutralization | 3.00 | 3.00 | 3.00 | 2.40 |
| | | Agent | | | | |
| 8 | DI Water | Solvent | 63.53 | 63.53 | 63.53 | 70.84 |
| | | | 100.00 | 100.00 | 100.00 | 100.00 |

### Preparation of the Acrylic

An acrylic shown in Table 2 was prepared according to the following procedure (amounts given in percent by weight):
1. Charge #1 was added to round bottom reaction flask. Condenser water and nitrogen blanket were turned on. Mixture was heated to 275-280° F., temperature set point at 286° F.
2. Batch temperature 275-280° F., charge #2 and 86.75% charge #3 were added over 180 minutes.
3. Once the feed was complete, rinse charge #4 was added. Batch was held for 15 minutes.
4. Once the hold was complete, 13.25% charge #3 was added over 10 minutes. When charge #3 addition was complete, batch was held 90 minutes.
6. Once the hold was complete, batch set point was reduced to 205° F.
7. Once batch temperature was below 205° F., charge #5 was added.
8. When charge #5 was complete, the batch was held for 30 minutes. During the hold, charge #6 was preheated to 160 ºF.
9. Once the hold was complete, the temperature set point was reduced to 160 ºF, and the preheated charge #6 was added over 25 minutes.
10. When charge #6 was complete, the batch was held for 120 minutes before full cooling was applied.

TABLE 2
Resin

| Charge | Material | Function | Acrylic |
|---|---|---|---|
| 1 | Butyl Cellosolve | Solvent | 14.21 |
| | Butanol | Solvent | 7.30 |
| 2 | Acrylic Acid | Monomer | 6.00 |
| | Butyl acrylate | Monomer | 21.49 |
| | N-Butoxymethyl | Monomer | 4.07 |
| | acrylamide solution | | |
| | Hydroxyethyl Acrylate | Monomer | 2.51 |
| | Methyl Methacrylate | Monomer | 15.01 |
| | Butyl Methacrylate | Monomer | 2.51 |
| | Styrene | Monomer | 2.51 |
| | Butyl Cellosolve | Solvent | 1.14 |
| 3 | T-Butyl Perbenzoate | Initiator | 1.04 |
| | Butyl Cellosolve | Solvent | 2.06 |
| 4 | Butanol | Solvent | 0.98 |
| 5 | DMEA | Neutralization Agent | 7.23 |
| 6 | DI Water | Solvent | 11.94 |
| | | | 100.00 |

### Preparation of Water-Based Over Varnish Compositions

The over varnish compositions of Tables 3 and 4 were prepared as follows (amounts given in percent by weight):
1. To the acrylic resin (as prepared above) was charged dimethylethanolamine and butyl cellosolve (if present). The mixture was stirred at room temperature for 1 minute at moderate speed using a laboratory mixer.
2. BPA polyol and CYMEL 303 LF were then charged to the vessel and stirred for a further 2-3 minutes at moderate speed.
3. The adhesion promoter, BYK-333, catalyst, and MAGIESOL 52 were all added individually during constant stirring at low speed.
5. A wax dispersion that contained the acrylic, waxes, and water was made in a separate vessel. The acrylic was stirred under moderate shear using a laboratory mixer and the waxes were slowly added. After the waxes were completely incorporated, the mixture was stirred under high shear for 10 minutes. The stirring was reduced to a low speed and water was added to reduce the dispersion.
6. The newly made wax dispersion was added to the over varnish mixture at low speed for 2 minutes. The coating was then diluted to the appropriate flow cup viscosity using water.

TABLE 3
Over varnish coating compositions with PTFE

| | | 35° C. Tg | 53° C. Tg | 85° C. Tg | 100° C. Tg |
|---|---|---|---|---|---|
| Material | Function | Example | Example | Example | Example |
| Acrylic Resin | Resin | 64.19 | 73.00 | 70.45 | 69.94 |
| Butyl Cellosolve | Solvent | | | 4.76 | 4.77 |
| Dimethylaminoethanol | Neutralizing | 0.17 | 0.16 | 0.29 | 0.29 |
| | Agent | | | | |
| BPA Polyol | Resin | 11.54 | 10.99 | 10.45 | 10.48 |
| CYMEL 303LF | Crosslinking | 11.77 | 11.21 | 10.66 | 10.69 |
| | material | | | | |
| Phosphatized Epoxy | Adhesion | 0.50 | 0.48 | 0.45 | 0.46 |
| Resin | Promoter | | | | |
| BYK-333 | Slip Agent | 0.12 | 0.12 | 0.11 | 0.11 |
| NACURE 155 | Catalyst | 0.41 | 0.39 | 0.37 | |
| NACURE 3525 | Catalyst | | | 0.00 | 0.81 |
| MAGIESOL 52 | Defoamer | 0.459 | 0.44 | 0.42 | 0.42 |
| Acrylic | Resin | 0.985 | 0.94 | 0.89 | 0.89 |
| Polyethylene | Wax | 0.249 | 0.24 | 0.23 | 0.23 |
| Polytetrafluoroethylene | Wax | 0.377 | 0.36 | 0.34 | 0.34 |
| Deionized water | Diluent | 9.234 | 1.69 | 0.59 | 0.59 |
| | | 100.00 | 100.00 | 100.00 | 100.00 |

TABLE 4
Over varnish coating compositions without PTFE

| | | 35° C. Tg | 53° C. Tg | 85° C. Tg | 100° C. Tg |
|---|---|---|---|---|---|
| Material | Function | Example | Example | Example | Example |
| Acrylic Resin | Resin | 64.19 | 73.20 | 70.64 | 70.12 |
| Butyl Cellosolve | Solvent | 0.00 | 0.00 | 4.77 | 4.78 |
| Dimethylaminoethanol | Neutralizing Agent | 0.17 | 0.16 | 0.29 | 0.29 |
| BPA Polyol | Resin | 11.54 | 11.02 | 10.48 | 10.51 |
| CYMEL 303LF | Crosslinking material | 11.77 | 11.24 | 10.69 | 10.71 |
| Adhesion Promoter | Adhesion Promoter | 0.50 | 0.48 | 0.46 | 0.46 |
| BYK-333 | Slip Agent | 0.12 | 0.12 | 0.11 | 0.11 |
| NACURE 155 | Catalyst | 0.39 | 0.39 | 0.37 | 0.00 |
| NACURE 3525 | Catalyst | 0.00 | 0.00 | 0.00 | 0.81 |
| MAGIESOL 52 | Defoamer | 0.459 | 0.44 | 0.42 | 0.42 |
| Acrylic | Resin | 1.03 | 0.98 | 0.93 | 0.94 |
| Polyethylene | Wax | 0.261 | 0.25 | 0.24 | 0.24 |
| Deionized water | Diluent | 9.571 | 1.72 | 0.61 | 0.62 |

*CYMEL 303LF is a methylated melamine crosslinker available commercially from Allnex.
BYK-333 is a polyeter modified polydimethylsiloxane available from Byk (Altana Group).
NACURE 155 (hydrophobic sulfonic acid catalyst) and NACURE 3525 (amine neutralized dinonylnaphthalenedisulfonic acid catalyst) are available from King Industries, Inc. MAGIESOL 52 (hydrotreated petroleum distillate) is available from Calumet Specialty Products Partners

### Preparation of Coated Cans

The over varnish was applied to the appropriate substrate using a Wagner Can Coater.
1. For over varnish application, 1.5-2.5 wraps were used to coat straightwalled, 2-piece aluminum can bodies.
2. The over varnishes were then cured for 1 minute at 400ºF in a box oven.
3. Inside Spray was then applied to the interior of the cans, and cured to reach a peak metal temperature (PMT) of over 380° F. for over 60 seconds, or a PMT of over 400ºF for 3 seconds.
4. Cans were necked using an 18-stage pilot necker.

### Test Methods

### AGR/Tilt Table Filled can Coefficient of Friction (COF)

An AGR Tilt Table Lubricity Tester and filled 2-piece beverage cans are used for this test. Two cans are placed on their side on the baseplate of the Tester and the slide bar is used to push the cans up against each other. A third filled can is then placed on its side on top of the first two cans, making a pyramid. The AGR Tilt Table is turned on, and the base plate begins to tilt upward. The top can will eventually slide off the two lower cans and hit a stop plate. The angle at which this occurs is recorded. Acceptable values for an over varnish may be 9-14°. Results are shown in Table 4.

### Altek Direct COF

An Altek 9505DAF1C Mobility/Lubricity tester and coated panels that are at least 3-inches by 6-inches and prepared with the proper bake cycles are used for this test. A 2-inch wide section of the panel is cut off and saved for Altek Face-to-Face testing. A 2 kg weight with three ball bearings is placed on the now 2-inches by 4-inches panel and attached to the drag hook. The equipment is turned on, the weight is pulled at a rate of 5 inches/min, generating an average Direct coefficient of friction. Acceptable values for an over varnish may be 0.030-0.100. Results are shown in Table 4.

### Altek Face-to-Face COF

An Altek 9505DAF1C Mobility/Lubricity tester and coated panels that are at least 3-inches by 6-inches and prepared with the proper bake cycles are used for this test. A 2-inch wide section of the panel is cut off and placed on top of the larger panel in a manner where the two coated sides are touching each other. A 2 kg weight with three ball bearings covered with felt is placed on top of the smaller, facedown panel, and the weight is attached to the drag hook. The equipment is turned on, the weight is pulled at a rate of 5 inches/min, generating an average Face-to-Face coefficient of friction. Acceptable values for an over varnish may be 0.060-0.150. Results are shown in Table 4.

### MEK Double Rubs

The test method used is similar to ASTM D5402, but a 2-pound ball-peen hammer is used in place of one's hand. A 4×4, 12ply piece of gauze is placed over the ball end of a 2-pound ball-peen hammer and secured with a rubber band. The gauze is then saturated with the methyl ethyl ketone (MEK), and then rubbed on the test panel using a back and forth stroke motion. Each back and forth stroke motion is counted as one “double rub” and the motion is continued until bare substrate is exposed in the center of the strip where the rubs are being performed. Acceptable values for MEK double rubs may be 20-100+, depending on inks and film weight. Results are shown in Table 4.

### Pencil Hardness

Test method is ASTM D3363. Ranges for over varnish may be from 2B-6H, preferably 3-6H. Results are shown in Table 4.

### TOCAT Test Method

Six cleaned, seamed, and filled cans are secured together as a six pack. The six pack is placed into the TQCAT instrument which applies pressure to the top and sides of the six pack. The cans are rocked back and forth for 10 minute intervals to simulate transportation abrasion. The cans are graded based on the amount of damage perceived along the abrasion points where the grading scale ranges from no perceivable damage to complete metal failure where the can would be leaking. This process is repeated a total of 60 minutes or until a can in the can pack leaks. Once the test is complete the total score is tallied based on each 10-minute grading session. Results are shown in Table 5.

TABLE 4
Cured Film Testing

| | 35° C. Tg | | 53° C. Tg | | 85° C. Tg | | 100° C. Tg | |
|---|---|---|---|---|---|---|---|---|
| | Example | | Example | | Example | | Example | |
| | With | No | With | No | With | No | With | No |
| Test Method | PTFE | PTFE | PTFE | PTFE | PTFE | PTFE | PTFE | PTFE |
| AGR - Filled Can | 13.8° | 13.3° | 11.3° | 14.0° | 10.7° | 13.6° | 12.0° | 12.3° |
| Altek - Direct | 0.05 | 0.06 | 0.05 | 0.08 | 0.07 | 0.10 | 0.05 | 0.05 |
| Altek - Face-to-Face | 0.07 | 0.08 | 0.11 | 0.12 | 0.10 | 0.14 | 0.06 | 0.07 |
| MEK DRs | 50.00 | 45.00 | 50.00 | 50.00 | 100+ | 100+ | 100+ | 100+ |
| Pencil Hardness | 5H | 5H | 5H | 5H | 5H | 5H | 5H | 5H |

TABLE 5
TQCAT Results

| 35° C. Tg Example | | | | 53° C. Tg Example | | | |
|---|---|---|---|---|---|---|---|
| With PTFE | | No PTFE | | With PTFE | | No PTFE | |
| MSI* | AS** | MSI | AS | MSI | AS | MSI | AS |
| 1.75 | 3360 | 1.75 | 840 | 1.52 | 3360 | 1.72 | 1480 |
| 2.47 | 3360 | 2.49 | 2760 | 2.00 | 3360 | 2.16 | 1700 |
| 85° C. Tg Example | | | | 100° C. Tg Example | | | |
| With PTFE | | No PTFE | | With PTFE | | No PTFE | |
| MSI | AS | MSI | AS | MSI | AS | MSI | AS |
| 1.57 | 3360 | 1.60 | 1980 | 1.50 | 3360 | 1.50 | 3360 |
| 2.00 | 3360 | 2.00 | 3360 | 2.18 | 3360 | 2.15 | 3360 |

*MSI = milligrams per square inch
**AS = Abrasion Score

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

1. An over varnish coating composition comprising:
a film-forming resin;
a crosslinking material; and
a lubricant;
wherein the over varnish coating composition is substantially free of polytetrafluoroethylene.

2. The coating composition of claim 1, wherein the film-forming resin comprises a polyester and/or an acrylic polymer.

3. The coating composition of claim 2, wherein the polyester comprises the reaction product of a polyacid and a polyol.

4. The coating composition of claim 2, wherein the acrylic comprises a one stage acrylic resin, a two stage acrylic resin, a solution polymerized acrylic resin, and/or a polyester grafted acrylic resin.

5. The coating composition of claim 1, wherein the film-forming resin has a Tg of 35° C. to 105° C.

6. The coating composition of claim 1, wherein the crosslinking material comprises a phenol and/or a melamine material.

7. The coating composition of claim 1, wherein at least 50 wt % of the crosslinking material comprises a melamine material based on the total solid weight of the crosslinking material.

8. The coating composition of claim 1, wherein the crosslinking material is in an amount of 10 wt % to 35 wt %, based on total weight of the coating composition.

9. The coating composition of claim 1, wherein the lubricant comprises polyethylene, polypropylene, carnauba wax, and/or lanolin wax.

10. The coating composition of claim 1, wherein the lubricant comprises a microcrystalline polyethylene.

11. The coating composition of claim 1, wherein the lubricant is in an amount of 0.1 wt % to 2 wt %, based on total weight of the coating composition.

12. The coating composition of claim 1, further comprising an additive, an adhesion promoter, a plasticizer, a surfactant, a flow control agent, a defoamer, a thixotropic agent, a filler, a diluent, an organic solvent, and/or a catalyst.

13. The coating composition of claim 1, wherein the coating composition is substantially aqueous.

14. The coating composition of claim 1, further comprising a matting agent.

15. The coating composition of claim 1, wherein the coating composition is a thermosetting composition.

16. A package coated on at least a portion of an external surface thereof with an over varnish derived from a coating composition of claim 1.

17. The package of claim 16, wherein the package comprises a metal can.

18. The package of claim 16, wherein the package comprises a food and/or beverage package.

19. The package of claim 16, wherein the over varnish is coated on at least a portion of an ink coating layer and/or an undercoat layer.

20. The package of claim 16, wherein a thickness of the over varnish layer is at least 2 μm.

21. (canceled)

22. (canceled)
